(19) United States
(12) Patent Application Publication
(10) Pub. No.: US 2026/0238549 A1
(43) Pub. Date: Aug. 13, 2026

(54) SYSTEMS AND METHODS FOR DYNAMIC SCALING IN NETWORK MAPS BASED ON PROXIMITY WITH OPTIONAL SUBSET GROUPING

(71) Applicant: Ciena Corporation, Hanover, MD (US)

(72) Inventor: Peter Brett Sinclair, Cambridge (CA)

(21) Appl. No.: 19/050,557

(22) Filed: Feb. 11, 2025

(51) Int. Cl. H04L 41/12; G06F 3/0484; H04L 41/22

(52) U.S. Cl. CPC H04L 41/12; H04L 41/22; G06F 3/0484

(57) ABSTRACT

A dynamic scaling network map system and method including and utilizing a display providing a user interface and a memory device storing dynamic scaling network map algorithm instructions executed by a processing device to display a plurality of displayed nodes and associated links on a network map on the user interface and dynamically apply a scale and a level of information detail to each of the plurality of displayed nodes independently based on a proximity of each of the plurality of displayed nodes to its closest neighbor displayed node on the network map to minimize overlap of the displayed nodes in crowded areas of the network map, maximize link visibility, and maximize the level of information detail provided in non-crowded areas of the network map. In some embodiments, the plurality of displayed nodes are a subset of a more broad plurality of displayed nodes of a network.

### TECHNICAL FIELD

The present disclosure relates generally to the telecommunications and networking fields. More particularly, the present disclosure relates to systems and methods for dynamic scaling in network maps based on proximity with optional subset grouping.

### BACKGROUND

When a network map displaying a network has too many nodes to show together with full detail, typical solutions include either applying a common scale for all nodes or clustering to summarize nodes in areas of the network map using fewer nodes.

If user interface (UI) or display performance is high enough, then the network map can show all nodes at once. But if the number of nodes is large and all nodes are shown at full scale, this may result in a huge number of overlapping nodes with too much clutter to see anything useful. Thus, a typical solution involves scaling all nodes down to a common fixed scale that reduces overlaps while still showing a reasonable amount of detail. When a user zooms in far enough, the scale can be increased but is typically applied in common for all nodes in the view.

Clusters collect nodes that are too close together at the current zoom level and show a smaller number of cluster nodes in their place, with each cluster node showing a summary of details from the contained nodes. When the user zooms in, a new set of clusters are shown based on the nodes that are still too close together in the view, until the user zooms in enough to see individual nodes in the available UI or display space. This may help with UI or display performance, as the network map only needs to show a small number of mostly clustered nodes at once, instead of all nodes in the view.

Thus, when the network map chooses a common scale such that the nodes are larger than the smallest separation between nodes, some nodes will be forced to overlap each other. These overlaps may hide topology between the nodes and hide detail for the nodes themselves. The user can zoom in to see within the overlaps, but by doing so the view is narrowed and the map shows less of the network. When the network map is scaled to be small enough such that no nodes overlap, this may result in all nodes being too small to see their details unless the user zooms in to the full extent, greatly narrowing the view.

Clusters hide the topology of nodes and links inside each cluster, limiting the network map to show only the high-level topology between clusters, except in very limited cases between individual nodes that are far enough away from each other that they are not clustered. Clusters summarize information like states and counts for their contained nodes, but in so doing they hide details and specific information about the individual nodes. If an activity involves nodes in different clusters, then often those nodes can never be shown at the same time because they may be inside a cluster at all zoom levels, interfering with user focus and usability.

The present background is provided as illustrative environmental context only. It will be readily apparent to those of ordinary skill in the art that the concepts and principles of the present disclosure may be implemented in other environmental contexts equally, without limitation.

### SUMMARY

The present disclosure addresses the above issues by scaling nodes independently instead of choosing a common scale for all nodes, thus reducing overlaps while showing more detail where there is enough room, with less detail shown in dense areas. Thus, the user does not need to zoom in as much to see node details. The user can see more topology in dense areas because the nodes there are smaller, and so the view can be wider while seeing more detail. The use of clusters to summarize details is avoided by default. Clusters are useful in some cases and sometimes requested by a user that prefers them, but in general hide too much detail.

In some embodiments, the present disclosure provides a dynamic scaling network map system including a display providing a user interface and a memory device storing dynamic scaling network map algorithm instructions executed by a processing device to display a plurality of displayed nodes and associated links on a network map on the user interface and dynamically apply a scale and a level of information detail to each of the plurality of displayed nodes independently based on a proximity of each of the plurality of displayed nodes to its closest neighbor displayed node on the network map to control (i.e., minimize) overlap of the displayed nodes in crowded areas of the network map, provide (i.e., maximize) link visibility, and control (i.e., maximize) the level of information detail provided in non-crowded areas of the network map. The dynamic scaling network map algorithm instructions are further executed by the processing device to restrict each of the plurality of displayed nodes to stay above a determined or selected minimum display size during the scale application such that all displayed nodes remain visible on the network map on the user interface. The dynamic scaling network map algorithm instructions are further executed by the processing device to restrict each of the plurality of displayed nodes to stay below a determined or selected maximum display size based on application logic during the scale application. In some embodiments, the application logic includes displayed node type. In some embodiments, the plurality of displayed nodes are a subset of a more broad plurality of displayed nodes of a network. The scale application is performed on a frame-by-frame basis as the network map is zoomed in or zoomed out. In some embodiments, the scale application is performed using graphics processing unit hardware acceleration. In some embodiments, the information detail includes displayed node shape, displayed node color, node type, node function information, and/or node status information.

In some embodiments, the present disclosure provides a dynamic scaling network map method including displaying a plurality of displayed nodes and associated links on a network map on a user interface provided on a display and dynamically applying a scale and a level of information detail to each of the plurality of displayed nodes independently based on a proximity of each of the plurality of displayed nodes to its closest neighbor displayed node on the network map to control (i.e., minimize) overlap of the displayed nodes in crowded areas of the network map, provide (i.e., maximize) link visibility, and control (i.e., maximize) the level of information detail provided in non-crowded areas of the network map. The dynamic scaling network map method further includes restricting each of the plurality of displayed nodes to stay above a determined or selected minimum display size during the scale application such that all displayed nodes remain visible on the network map on the user interface. The dynamic scaling network map method further includes restricting each of the plurality of displayed nodes to stay below a determined or selected maximum display size based on application logic during the scale application. In some embodiments, the application logic includes displayed node type. In some embodiments, the plurality of displayed nodes are a subset of a more broad plurality of displayed nodes of a network. The scale application is performed on a frame-by-frame basis as the network map is zoomed in or zoomed out. In some embodiments, the scale application is performed using graphics processing unit hardware acceleration. In some embodiments, the information detail includes displayed node shape, displayed node color, node type, node function information, and/or node status information.

In some embodiments, the present disclosure provides a non-transitory computer-readable medium including dynamic scaling network map algorithm instructions stored in a memory device and executed by a processing device to carry out the steps including displaying a plurality of displayed nodes and associated links on a network map on a user interface provided on a display and dynamically applying a scale and a level of information detail to each of the plurality of displayed nodes independently based on a proximity of each of the plurality of displayed nodes to its closest neighbor displayed node on the network map to control (i.e., minimize) overlap of the displayed nodes in crowded areas of the network map, provide (i.e., maximize) link visibility, and control (i.e., maximize) the level of information detail provided in non-crowded areas of the network map. The steps further include restricting each of the plurality of displayed nodes to stay above a determined or selected minimum display size during the scale application such that all displayed nodes remain visible on the network map on the user interface and restricting each of the plurality of displayed nodes to stay below a determined or selected maximum display size based on application logic during the scale application. In some embodiments, the plurality of displayed nodes are a subset of a more broad plurality of displayed nodes of a network. The scale application is performed on a frame-by-frame basis as the network map is zoomed in or zoomed out.

It will be readily apparent to those of ordinary skill in the art that aspects and features of the various described embodiments may be included, omitted, or combined as desired in a given application, without limitation.

### BRIEF DESCRIPTION OF THE DRAWINGS

The present disclosure is illustrated and described with reference to the various drawings, in which like reference numbers are used to denote like assembly components/method steps, as appropriate.

FIG. 1 is a schematic diagram illustrating one embodiment of the dynamic scaling network map system of the present disclosure.

FIG. 2 is a flowchart illustrating one embodiment of the dynamic scaling network map method of the present disclosure.

FIG. 3 is an example UI network map display generated by the dynamic scaling network map system and method of the present disclosure.

FIG. 4 is another example UI network map display generated by the dynamic scaling network map system and method of the present disclosure.

FIG. 5 is a further example UI network map display generated by the dynamic scaling network map system and method of the present disclosure.

FIG. 6 is a schematic diagram illustrating an example system architecture that may incorporate or implement the dynamic scaling network map system and method of the present disclosure.

It will be readily apparent to those of ordinary skill in the art that aspects and features of the various illustrated embodiments may be included, omitted, or combined as desired in a given application, without limitation.

### DETAILED DESCRIPTION

The present disclosure provides a network map UI that reduces displayed node overlaps and increases visible detail beyond typical levels when the network map needs to show many nodes at once, especially for geographic or fixed-coordinate map data that has areas of widely varying node density.

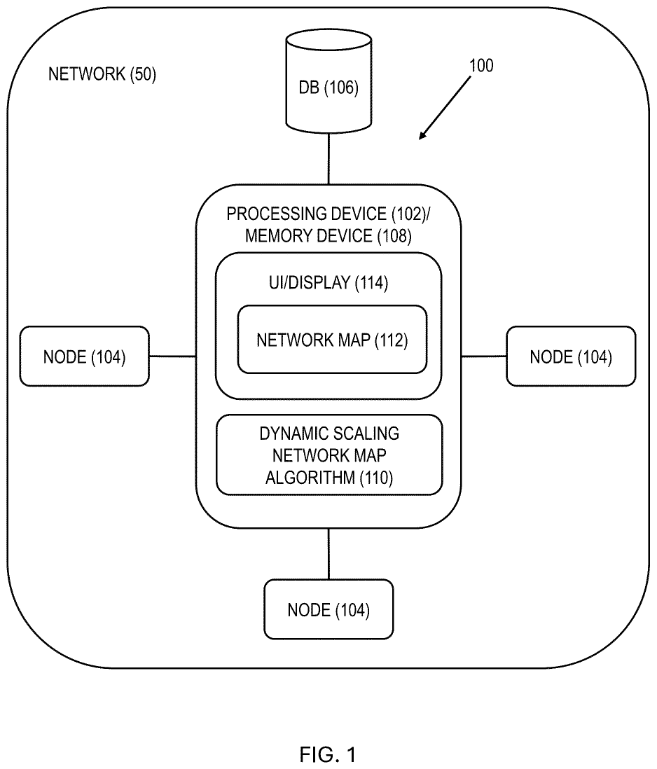

Referring to FIG. 1, in one embodiment, the dynamic scaling network map system 100 includes a processing device 102 that receives data regarding the location, connectivity, and specifics of a plurality of nodes 104 of a network 50, either directly from the plurality of nodes 104 or from a database (DB) 106 containing such information. Further, this DB 106 may contain geographic/map data. A memory device 108 associated with the processing device 102 also stores the dynamic scaling network map algorithm 110 of the present disclosure, as described in greater detail below. The dynamic scaling network map algorithm 110 is executed by the processing device 102 to generate a network map 112 that is displayed to a user via a UI/display 114 associated with the processing device 102.

The dynamic scaling network map algorithm 110 is executed to, on a frame-by-frame basis, dynamically vary the scale of each displayed node (corresponding to each node 104), as well as the level of information detail associated with each displayed node, based on the proximity of each displayed node to its closest neighbor displayed node on the network map 112 in the UI/display 114. Scales are applied separately and independently for each displayed node, and the same scale is not applied for all displayed nodes. This allows the network map 112 to provide more information detail where there is enough room on the UI/display 114, and provide less information detail in crowded areas on the UI/display 114, with node connectivity/topology being visible to the maximum extent in all cases. The methodology applied is described in greater detail below.

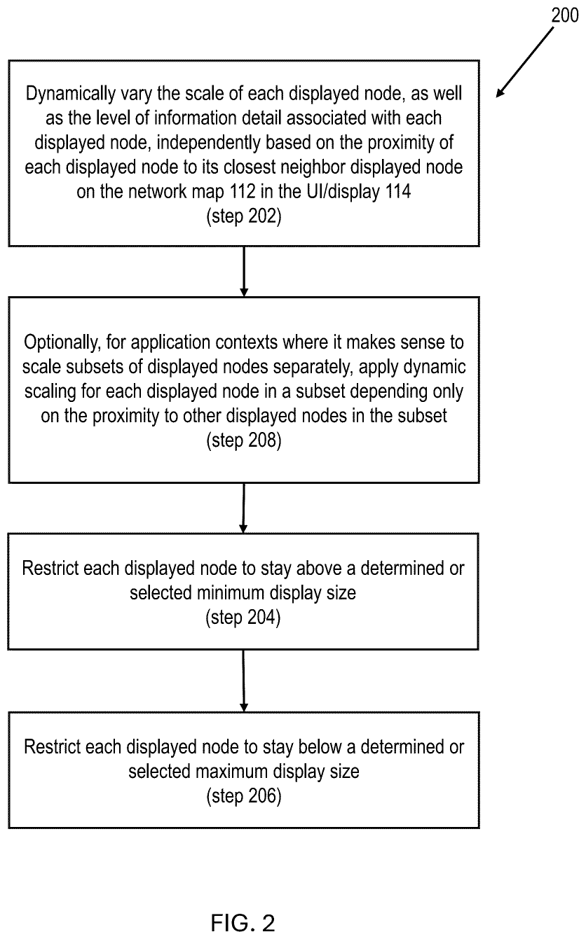

Referring to FIG. 2, in one embodiment, the dynamic scaling network map method 200 again includes dynamically varying the scale of each displayed node (corresponding to each node 104), as well as the level of information detail associated with each displayed node, based on the proximity of each displayed node to its closest neighbor displayed node on the network map 112 in the UI/display 114 (step 202). Scales are applied separately and independently for each displayed node, and the same scale is not applied for all displayed nodes. This allows the network map 112 to provide more information detail where there is enough room on the UI/display 114, and provide less information detail in crowded areas on the UI/display 114, with node connectivity/topology being visible to the maximum extent in all cases.

The dynamic scaling network map method 200 also includes restricting each displayed node to stay above a determined or selected minimum display size (step 204), such that all displayed nodes remain visible when zoomed out and do not shrink down to an invisible display size. This means that overlaps may happen at minimum display size, but that is acceptable because at that point there is not much information detail to be hidden by such overlaps.

The dynamic scaling network map method 200 further includes restricting each displayed node to stay below a determined or selected maximum display size (step 206). The maximum display size can be different for each displayed node, depending on the application logic (e.g., amplifiers could be smaller in terms of display size than other types of nodes). Sizing based on the application logic becomes less meaningful when other dynamic scaling rules are applied, but may still be useful when the displayed nodes have enough separation on the network map 112.

Optionally, for application contexts where it makes sense to scale subsets of displayed nodes separately, the dynamic scaling network map method 200 still further includes applying dynamic scaling for each displayed node in a subset depending only on the proximity to other displayed nodes in the subset (step 208), ignoring other displayed nodes not in the subset. This prevents displayed nodes in the subset from overlapping other displayed nodes in the subset, but allows them to overlap displayed nodes outside the subset. The above minimum and maximum display size rules still apply.

The above displayed node scaling rules are applied continuously, on a frame-by-frame basis, while the user zooms in or out. This may be implemented with graphics processing unit (GPU) hardware acceleration, to adjust all displayed node scales independently and dynamically on a per-frame basis as the user zooms in or out, smoothly adding more information detail in specific areas as room becomes available on the UI/display 114, for example.

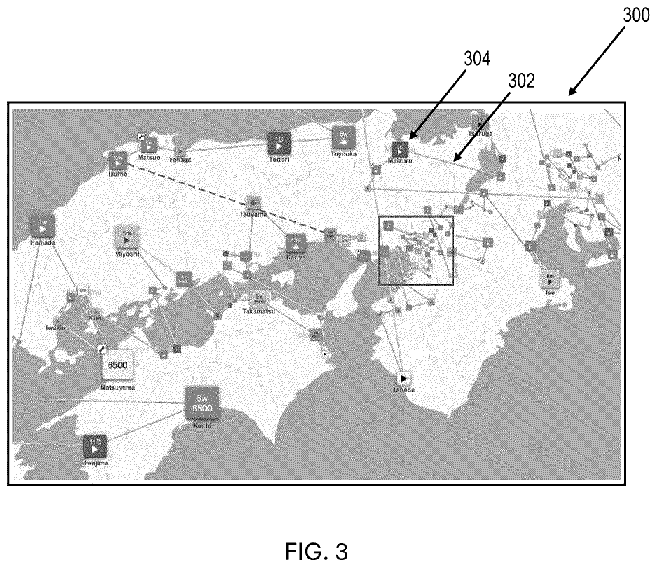

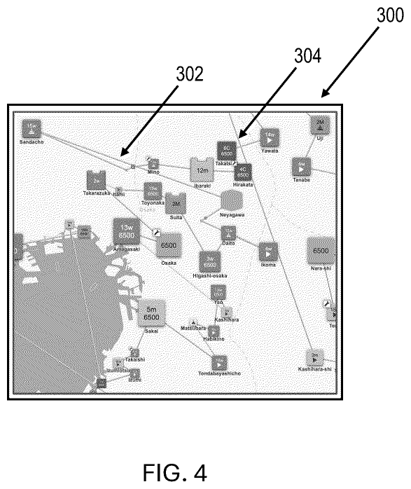

FIG. 3 is an example UI network map display 300 generated by the dynamic scaling network map system 100 and method 200 of the present disclosure, showing the displayed links 302 between the displayed nodes 304 that have been dynamically (and independently) scaled as described above. The area in the square overlay is zoomed in and illustrated in FIG. 4.

Of note in the zoomed-out network map display 300 of FIG. 3, some displayed nodes 304, mostly to the right, have proximity closer together and so they are scaled down to a small display size to avoid overlapping each other, with all information details hidden other than color and shape, but with topology between the displayed nodes 304 still clearly visible via the displayed links 302. Some displayed nodes 304, mostly to the left, are far enough away from other displayed nodes 304 that they can be shown at full scale, showing names below each displayed node 304 and information details like an “8w” alarm count and a “6500” device type. A range of scales and information detail levels (color, shape, notations, etc.) are used between the minimum and maximum display sizes, to show the most detail possible for each displayed node 304 without overlapping other displayed nodes 304.

Network map interaction can then allow the user to zoom in to see more information detail for displayed nodes 304 that were too small at the previous zoom level. For example, in the zoomed-in network map display 300 of FIG. 4, in the dense area in the middle-right of FIG. 3 denoted by the square overlay, the same rules apply. Most displayed nodes 304 appear larger and show more information detail because they are further apart at this zoom level, but a few displayed nodes 304 are small because they are still too close, and most displayed nodes are somewhere below their maximum display size.

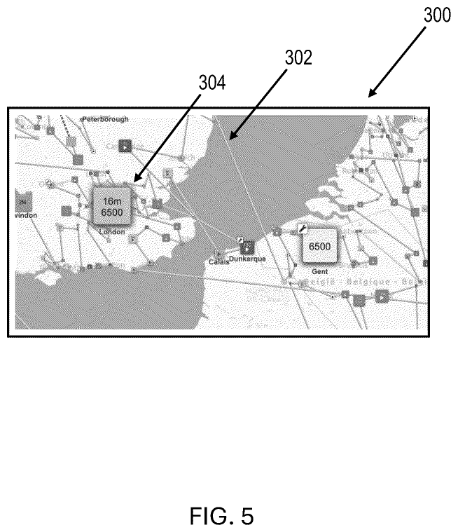

As mentioned above, this concept can also be applied separately to specific displayed nodes 304 or subsets of displayed nodes 304 where the user wants to allow overlaps, for various application-specific reasons and contexts. As an example, FIG. 5 shows two selected displayed nodes 304 highlighted, London and Gent, that are scaled separately and allowed to overlap other displayed nodes 304 in the network map display 300, making those two displayed nodes 304 clearly visible above the rest. Proximity scaling still applies between these two displayed nodes 304, and so if the user zooms out far enough then London and Gent would scale down dynamically to avoid overlapping each other. More complex examples would include more displayed nodes 304 in the subset, some closer together to cause scaling that avoids overlapping displayed nodes 304 in the subset.

Thus, per the present disclosure, using a different scale for each displayed node 304 reduces overlaps except in subsets where the user chooses to allow overlaps. Interactions allow the user to bring what they want into focus, and GPU hardware acceleration adjusts the individual displayed node scales dynamically and smoothly as the user zooms.

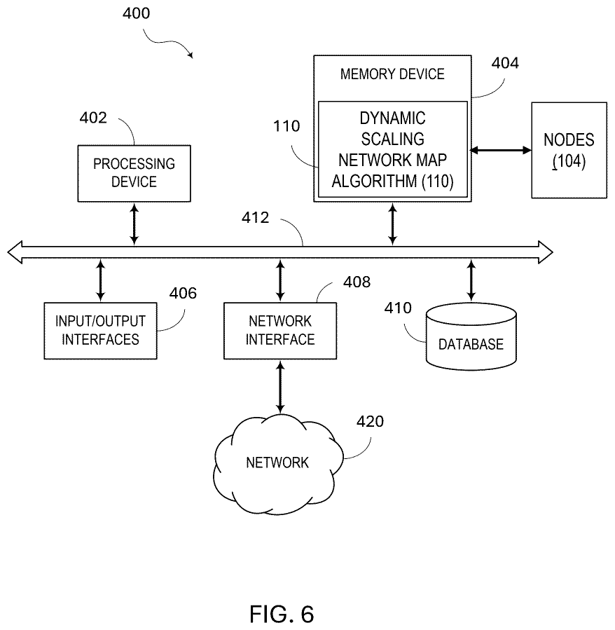

FIG. 6 is a schematic diagram showing an example processing environment 400 in which the dynamic scaling network map algorithm 110 of the present disclosure may be implemented. The processing environment 400 generally includes a processing device 402 (such as processing device 102), a memory device 404 (such as memory device 108), input/output (I/O) interfaces 406, a network interface 408, and a database 410 (such as database 106). It should be appreciated that the processing environment is illustrated in a simplified manner, where some embodiments may include additional components and suitably configured processing logic to support known or conventional operating features. The components may be communicatively coupled via a local interface 92. The local interface 412 may include, for example, one or more buses or other wired or wireless connections. The local interface 412 may also include controllers, buffers, caches, drivers, repeaters, receivers, among other elements, to enable communication. Further, the local interface 412 may include address, control, and/or data connections to enable appropriate communications among the components.

It should be appreciated that the processing device 402, according to some embodiments, may include or utilize one or more generic or specialized processors (e.g., microprocessors, central processing units (CPUs), digital signal processors (DSPs), network processors (NPs), network processing units (NPUs), graphics processing units (GPUs), field programmable gate arrays (FPGAs), semiconductor-based devices, chips, and/or the like). The processing device 412 may also include or utilize stored program instructions (e.g., stored in hardware, software, and/or firmware) for control of the processing environment 400 by executing the program instructions to implement some or all of the functions of the systems and methods described. Alternatively, some or all functions may be implemented by a state machine that may not necessarily include stored program instructions, may be implemented in one or more application specific integrated circuits (ASICs), and/or may include functions that can be implemented as custom logic or circuitry. Of course, a combination of the aforementioned approaches may be used. For some of the embodiments described, a corresponding device in hardware (and optionally with software, firmware, and combinations thereof) can be referred to as “circuitry” or “logic” that is “configured to” or “adapted to” perform a set of operations, steps, methods, processes, algorithms, functions, techniques, etc., on digital and/or analog signals as described herein with respect to various embodiments.

The memory device 404 may include volatile memory elements (e.g., random access memory (RAM), dynamic RAM (DRAM), synchronous DRAM (SDRAM), static RAM (SRAM), and/or the like), nonvolatile memory elements (e.g., read only memory (ROM), programmable ROM (PROM), erasable PROM (EPROM), electrically erasable PROM (EEPROM), hard drive, tape, compact disc ROM (CD-ROM), and/or the like), and/or combinations thereof. Moreover, the memory device 404 may incorporate electronic, magnetic, optical, and/or other types of storage media. The memory device 404 may have a distributed architecture, where various components are situated remotely from one another, but can be accessed by the processing device 402.

The memory device 404 may include a data store, a database (e.g., database 410), and/or the like, for storing data. In one example, the data store may be located internal to the processing environment 400 and may include, for example, an internal hard drive connected to the local interface 412. Additionally, in another embodiment, the data store may be located external to the processing environment 400 and may include, for example, an external hard drive connected to the I/O interfaces 406. In a further embodiment, the data store may be connected to the processing environment through a network and may include, for example, a network attached file server.

Software stored in the memory device 404 may include one or more programs, each of which may include an ordered listing of executable instructions for implementing logical functions. The software in the memory device 404 may also include a suitable operating system (O/S) and one or more computer programs. The O/S essentially controls the execution of other computer programs, and provides scheduling, input/output control, file and data management, memory management, and communication control and related services. The computer programs may be configured to implement the various processes, algorithms, methods, techniques, etc. described.

Moreover, some embodiments may include non-transitory computer-readable media having instructions stored thereon for programming or enabling a computer, server, processor (e.g., processing device 402), circuit, appliance, device, etc. to perform functions as described. Examples of such non-transitory computer-readable medium may include a hard disk, an optical storage device, a magnetic storage device, a ROM, a PROM, an EPROM, an EEPROM, flash memory, and/or the like. When stored in the non-transitory computer-readable medium, software can include instructions executable (e.g., by the processing device 402 or other suitable circuitry or logic). For example, when executed, the instructions may cause or enable the processing device 402 to perform a set of operations, steps, methods, processes, algorithms, functions, techniques, etc. as described according to the various embodiments.

The methods, sequences, steps, techniques, and/or algorithms described in connection with the embodiments disclosed may be embodied directly in hardware, in software/firmware modules executed by a processor (e.g., processing device 402), or any suitable combination thereof. Software/firmware modules may reside in the memory device 404, memory controllers, double data rate (DDR) memory, RAM, flash memory, ROM, PROM, EPROM, EEPROM, registers, hard disks, removable disks, CD-ROMs, and/or any other suitable storage medium.

Those of ordinary skill in the art will appreciate that various embodiments may be described in terms of logical blocks, modules, circuits, algorithms, steps, and sequences of actions, which may be performed or otherwise controlled with a general purpose processor, a DSP, an ASIC, an FPGA, programmable logic devices, discrete gates, transistor logic, discrete hardware components, elements associated with a computing device, controller, state machine, or any suitable combination thereof designed to perform or otherwise control the functions described.

The I/O interfaces 406 may be used to receive user input from and/or for providing system output to one or more devices or components. For example, user input may be received via one or more of a keyboard, a keypad, a touchpad, a mouse, and/or other input receiving devices. System outputs may be provided via a display device, monitor, user interface (UI), graphical user interface (GUI), a printer, and/or other user output devices. I/O interfaces 406 may include, for example, one or more of a serial port, a parallel port, a small computer system interface (SCSI), an Internet SCSI (iSCSI), an advanced technology attachment (ATA), a serial ATA (SATA), a fiber channel, InfiniBand, a peripheral component interconnect (PCI), a PCI extended interface (PCI-X), a PCI express interface (PCIe), an infrared (IR) interface, a radio frequency (RF) interface, and/or a universal serial bus (USB) interface.

The network interface 408 may be used to enable communication over or with a network 420, the Internet, a wide area network (WAN), a local area network (LAN), and/or the like. The network interface 408 may include, for example, an ethernet card or adapter (e.g., 10BaseT, fast ethernet, gigabit ethernet, 10GbE) or a wireless LAN (WLAN) card or adapter (e.g., 802.11a/b/g/n/ac). The network interface 408 may include address, control, and/or data connections to enable appropriate communications on the network 420.

The network environment 400 includes the dynamic scaling network map algorithm 110 of the present disclosure, which may be implemented in hardware, software, or firmware and stored in any suitable non-transitory computer-readable medium (e.g., memory device 404, database 410, and/or the like).

Although the present disclosure is illustrated and described with reference to illustrative embodiments and examples, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following non-limiting claims for all purposes.

What is claimed is:

1. A dynamic scaling network map system comprising
a display providing a user interface, and
a memory device storing dynamic scaling network map algorithm instructions executed by a processing device to
display a plurality of displayed nodes and associated links on a network map on the user interface, and
dynamically apply a scale and a level of information detail to each of the plurality of displayed nodes independently based on a proximity of each of the plurality of displayed nodes to its closest neighbor displayed node on the network map to control overlap of the displayed nodes in crowded areas of the network map and provide link visibility.

2. The dynamic scaling network map system of claim 1, wherein the dynamic scaling network map algorithm instructions are further executed by the processing device to restrict each of the plurality of displayed nodes to stay above a determined or selected minimum display size during the scale application such that all displayed nodes remain visible on the network map on the user interface.

3. The dynamic scaling network map system of claim 1, wherein the dynamic scaling network map algorithm instructions are further executed by the processing device to restrict each of the plurality of displayed nodes to stay below a determined or selected maximum display size based on application logic during the scale application.

4. The dynamic scaling network map system of claim 3, wherein the application logic includes displayed node type.

5. The dynamic scaling network map system of claim 1, wherein the plurality of displayed nodes are a subset of a more broad plurality of displayed nodes of a network.

6. The dynamic scaling network map system of claim 1, wherein the scale application is performed on a frame-by-frame basis as the network map is zoomed in or zoomed out.

7. The dynamic scaling network map system of claim 6, wherein the scale application is performed using graphics processing unit hardware acceleration.

8. The dynamic scaling network map system of claim 1, wherein the information detail includes displayed node shape, displayed node color, node type, node function information, and/or node status information.

9. A dynamic scaling network map method comprising
displaying a plurality of displayed nodes and associated links on a network map on a user interface provided on a display, and
dynamically applying a scale and a level of information detail to each of the plurality of displayed nodes independently based on a proximity of each of the plurality of displayed nodes to its closest neighbor displayed node on the network map to control overlap of the displayed nodes in crowded areas of the network map and provide link visibility.

10. The dynamic scaling network map method of claim 9, further comprising restricting each of the plurality of displayed nodes to stay above a determined or selected minimum display size during the scale application such that all displayed nodes remain visible on the network map on the user interface.

11. The dynamic scaling network map method of claim 9, further comprising restricting each of the plurality of displayed nodes to stay below a determined or selected maximum display size based on application logic during the scale application.

12. The dynamic scaling network map method of claim 11, wherein the application logic includes displayed node type.

13. The dynamic scaling network map method of claim 9, wherein the plurality of displayed nodes are a subset of a more broad plurality of displayed nodes of a network.

14. The dynamic scaling network map method of claim 9, wherein the scale application is performed on a frame-by-frame basis as the network map is zoomed in or zoomed out.

15. The dynamic scaling network map method of claim 14, wherein the scale application is performed using graphics processing unit hardware acceleration.

16. The dynamic scaling network map method of claim 9, wherein the information detail includes displayed node shape, displayed node color, node type, node function information, and/or node status information.

17. A non-transitory computer-readable medium comprising dynamic scaling network map algorithm instructions stored in a memory device and executed by a processing device to carry out the steps comprising
displaying a plurality of displayed nodes and associated links on a network map on a user interface provided on a display, and
dynamically applying a scale and a level of information detail to each of the plurality of displayed nodes independently based on a proximity of each of the plurality of displayed nodes to its closest neighbor displayed node on the network map to control overlap of the displayed nodes in crowded areas of the network map and provide link visibility.

18. The non-transitory computer-readable medium of claim 17, the steps further comprising
restricting each of the plurality of displayed nodes to stay above a determined or selected minimum display size during the scale application such that all displayed nodes remain visible on the network map on the user interface, and
restricting each of the plurality of displayed nodes to stay below a determined or selected maximum display size based on application logic during the scale application.

19. The non-transitory computer-readable medium of claim 17, wherein the plurality of displayed nodes are a subset of a more broad plurality of displayed nodes of a network.

20. The non-transitory computer-readable medium of claim 17, wherein the scale application is performed on a frame-by-frame basis as the network map is zoomed in or zoomed out.
